(19) United States
(12) Patent Application Publication
(10) Pub. No.: US 2017/0027811 A1
(43) Pub. Date: Feb. 2, 2017

(54) Sexual Stimulation Device Base

(71) Applicant: Michael Edward Thomas, San Jose, CA (US)

(72) Inventor: Michael Edward Thomas, San Jose, CA (US)

(21) Appl. No.: 14/815,209

(22) Filed: Jul. 31, 2015

(51) Int. Cl. A61H 19/00

(52) U.S. Cl. CPC A61H 19/44; A61H 19/40; A61H 2205/087

(57) ABSTRACT

One embodiment of the base of a sexual stimulation device such as a dildo or anal plug having three legs (2, 3, 4) radiating horizontally out at the base, from the vertical axis of the insertable portion of the device, which support the sexual stimulation device in an upright position, prevent the accidental and possible irretrievable over insertion of the sexual stimulation device and which two (2,3) of the three legs are arranged so as to create a void between those two legs (2,3) thus providing unobstructed exposure to the users perineum. This alignment of the three legs (2, 3, 4) and the void created allows for increased stimulation of the perineum and increased sexual gratification of not only the user, but when used in conjunction with a partner, their partner as well by minimizing or completely eliminating the obstruction of the users anogenital region.

### BACKGROUND

### Prior Art

The following is a tabulation of some prior art that presently appears relevant:

U.S. Patents

| Pat. No. | Kind Code | Issue Date | Patentee |
|---|---|---|---|
| 8,398,539 | B2 | Mar. 19, 2013 | Stevens |
| 5,871,533 | | Feb. 16, 1999 | Boutos |
| 5,573,499 | | Nov. 12, 1996 | McAlister |
| 6,246,915 | B1 | Jun. 12, 2001 | Boutos |
| 8,734,322 | B2 | May 27, 2014 | Cordle |

### Nonpatent Literature Documents

Pleasure Works Wholesale, Online catalog, July 2015, pages 17
Fun Factory, Winter-Spring 2015 Catalog, pages 34-41
Doc Johnson Enterprises, 2015 Catalog, with Summer Supplement, pages 3, 5, 7, 19, 49

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Phalluses, dildos, vibrators, anal/butt plugs and other sexual stimulation devices and toys are distributed throughout the world generally in sexual novelty shops and through Internet merchants. These devices can be used as adult sexual aids, gag gifts, art pieces and collectibles. Usually, however, their primary purpose is that of a sexual stimulant when inserted into a body cavity.

Dildos and vibrators are usually phallic shaped so as to resemble the form (if not the size) of the penis or phallus. Typically, the term “dildo” generally refers to and includes phallic-shaped devices that are static or non-vibrating, while the term “vibrator” generally refers to and includes phallic-shaped devices that include a system for causing vibration of the device. Vibrators can also be shaped in other ways besides phallic shaped, and/or be provided such that they are not anatomically correct. As used herein, “phallus” is any shaped device that can be used as a sexual stimulation aid when inserted vaginally or anally in women, or anally in men. These phalluses can be used in many variations of support, including but not limited to self-standing on their base, attached to a suitable hard surface via suction device either permanently built-in or detachable, attached to a suitable harness or strap such that the phallus can be worn by a user to simulate coitus, or merely used by hand-held manipulation, among others.

“Anal plugs” or “butt plugs” are generally similarly phallic shaped and or shaped in such a way as to provide stimulation to the internal structures or organs surrounding the anal rectal cavity, such as the prostate, g-spot and other related structures and organs. As used herein, “anal plug” is any shaped device that can be used as a sexual stimulation aid when inserted anally in either men or women. Anal plugs may or may not include a system for causing vibration, however they feature a flared base or handle that is designed to prevent the anal plug from being accidentally fully inserted and thus not easily retrievable.

In prior art, the base of the phallus or anal plug is generally designed for the purpose of either supporting the device upright, supporting the device by suction, supporting and/or anchoring the device in a wearable harness or strap-on or for preventing accidental and possible irretrievable full insertion into the rectum or vagina of the user. As used herein, “strap-on” is a sexual device system utilizing a phallus or anal plug that can be either held in place on or affixed to a suitable harness or strap worn by a user on or about any part of the body, thus being used as a sexual stimulation aid for penetrating a body orifice of another person.

Prior art reveals these bases are typically sufficient in size and shape such that they radiate outwardly perpendicular to the inserted portion of the device, in the shape of a circle, rectangle, square, modified elliptical shape or other anatomically enhanced shape from the medial center line of the longitudinal axis of the shaft of the phallus or anal plug. These prior art devices have bases which when inserted anally are of such a shape and size that they effectively prevent and/or inhibit access to and thus sexual stimulation of the user's perineum, and/or partially or completely block access to the woman's vaginal opening thus sufficiently interfering with or effectively blocking the ease and comfort of the user being penetrated vaginally by a penis, phallus, anal plug or strap-on. The prior art bases of these phalluses, anal plugs and strap-on's interfere with and or make contact with the male partner's penis during vaginal coitus when the female user has the phallus or anal plug inserted into the rectum, thus diminishing their mutual sexual satisfaction.

Many variations exist and have been proposed, such as the U.S. Pat. No. 6,246,915 (2001), U.S. Pat. No. 5,871,533 (1999) and U.S. Pat. No. 5,800,502 (1998) to Boutos, which features an elliptical or circular base that is flat and of a configuration that would partially or fully cover part of the users perineum, if not all of it when in use.

U.S. Pat. No. 8,734,322 to Cordle features an adhesive strip to attach a vibrator to the female genitalia, with two bifurcated arms which adhere the device to the wearer, while allowing for access to the wearers vagina. Still this application does not provide for the insertion of the prior art, its design is simply one that attaches the devise to the wearer/user. In the case of U.S. Pat. No. 5,573,499 (1996) to McAlister, variations of the base include a suction cup, the very nature of which is circular. In this case the base suction cup appears to be used for attachment to a smooth surface for support only. And lastly, U.S. Pat. No. 8,398,539 (2013) to Stevens again indicates a simple circular base which would merely provide attachment of the base to the device, providing support and possibly interfering with the user's perineum. In each application of the bases of prior art, the functionality has primarily focused on either attachment to other implements or prevention of accidental over insertion.

On page 17 of the Pleasure Works online catalog, several iterations of an anal plug indicate a linear tapered base, both centered and offset as in the “Don Juan”. While these bases are more ergonomic in design than typical round bases of prior art thus allowing for a more comfortable fit between the user's buttocks, they do not provide enhanced access to the user's perineum, but instead cover and or block access.

Similar design features are found on many other sexual stimulation devices, such as on pages 34 through 41 of the Fun Factory Winter-Spring 2015 catalog. A rounded three-sided base is presented on page 35, without providing viable access to the user's perineum due to the equilateral spacing of the three rounded sides. These modifications appear to provide less functional duty and are more as a design element. Further there are within these same catalog pages sexual stimulation devices that feature simple anatomically designed linear tapered bases, which while more comfortable for the user, do not provide for unimpeded access to the user's perineum.

Doc Johnson Enterprises 2015 catalog features numerous examples of sexual stimulation devices that have bases that are modified from a more standard circular base to one which is more anatomically correct as with other prior art. On page 3, an oval base as well as a linear base is shown, neither of which improve access to the user's perineum, but in fact still block such access. On pages 5, 7, 19 and 49, numerous iterations are shown that are liner in design. These designs provide support for the devices, prevent accidental and potentially irretrievable over insertion, and while potentially more comfortable for the user than a standard round base, they further inhibit access to the user's highly sensitive perineum.

### BRIEF SUMMARY

The present invention and its embodiments provides support for the phallus or anal plug in an upright position, or while attached to a strap-on harness and prevents the accidental and possible irretrievable full insertion, while at the same time said base features three legs strategically designed to allow for the full and complete access to the user's perineum, and related erogenous zones.

### Advantages of the Present Invention

The present invention relates to the design and use of the base of the prior art, such that the base is configured to allow for the upright self support of the phallus, anal plug or its embodiments, the prevention of accidental and possible irretrievable full insertion into the rectum or vagina of the user while simultaneously allowing for complete and unimpeded access to the user's perineum. As well the present invention allows for unimpeded access to and penetration of the anus by a penis, phallus, anal plug or strap-on in the case of vaginal use, and unimpeded access to and penetration of the vagina by a penis, phallus, anal plug or strap-on in the case of anal use by a female, enhancing sexual stimulation. In the case of use by a male, the present invention allows for unimpeded access to the scrotum for enhanced sexual stimulation.

### DRAWINGS

### Figures

In the drawings, closely related figures have the same number but different alphabetic suffixes.

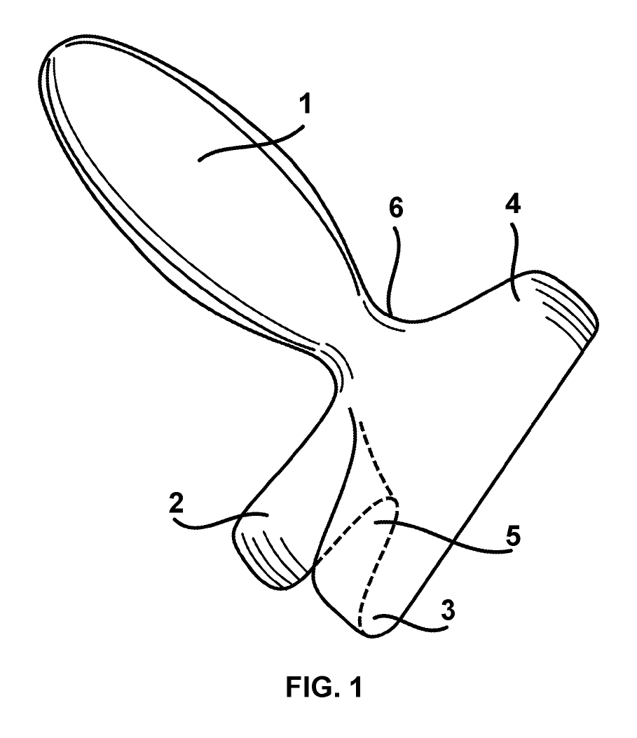

FIG. 1 shows a perspective view of the present invention, the base of an anal plug.

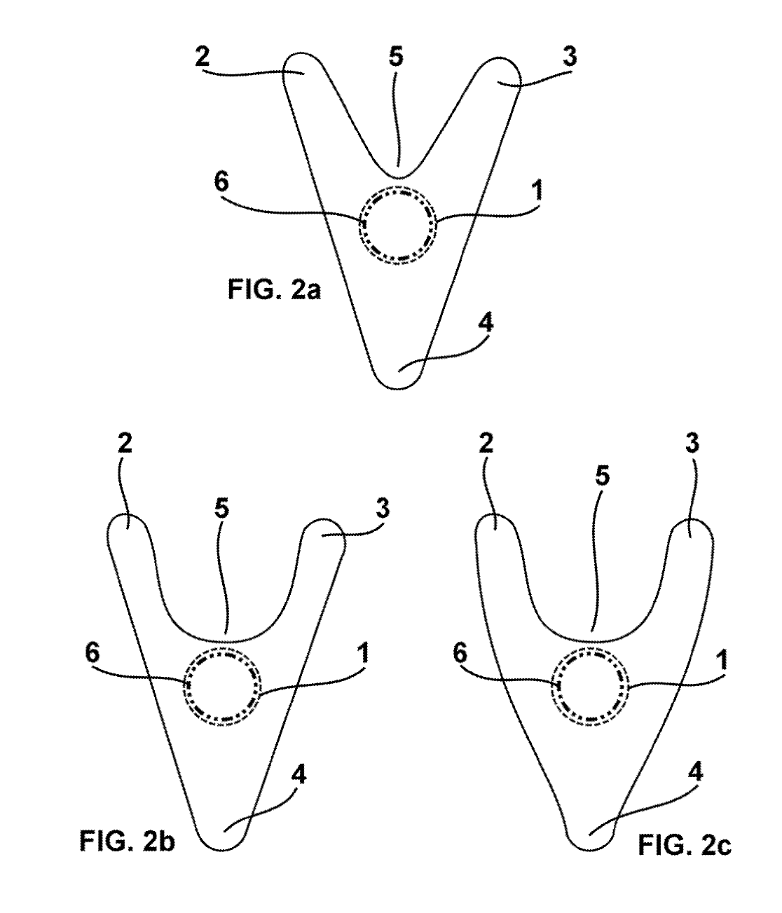

FIGS. 2A to 2C shows plan views of the present invention demonstrating the various embodiments viewed in plan view.

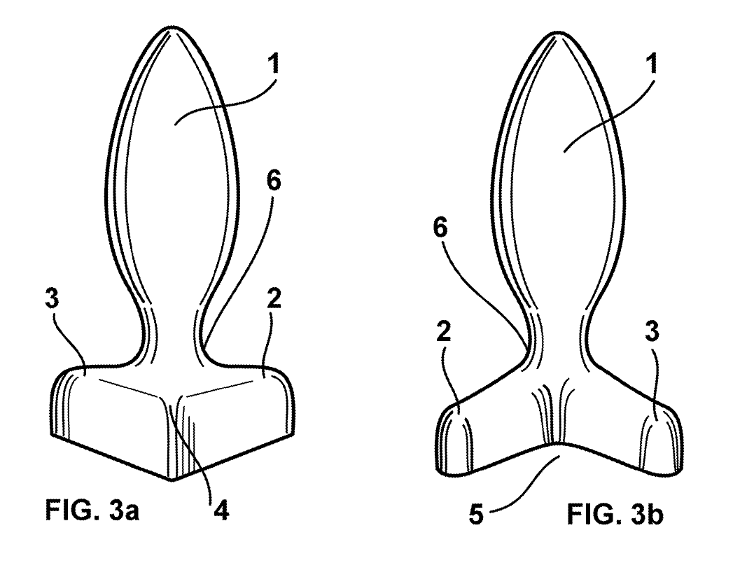

FIG. 3A to 3B show orthogonal views of the present invention from the front and the back demonstrating the preferred embodiment.

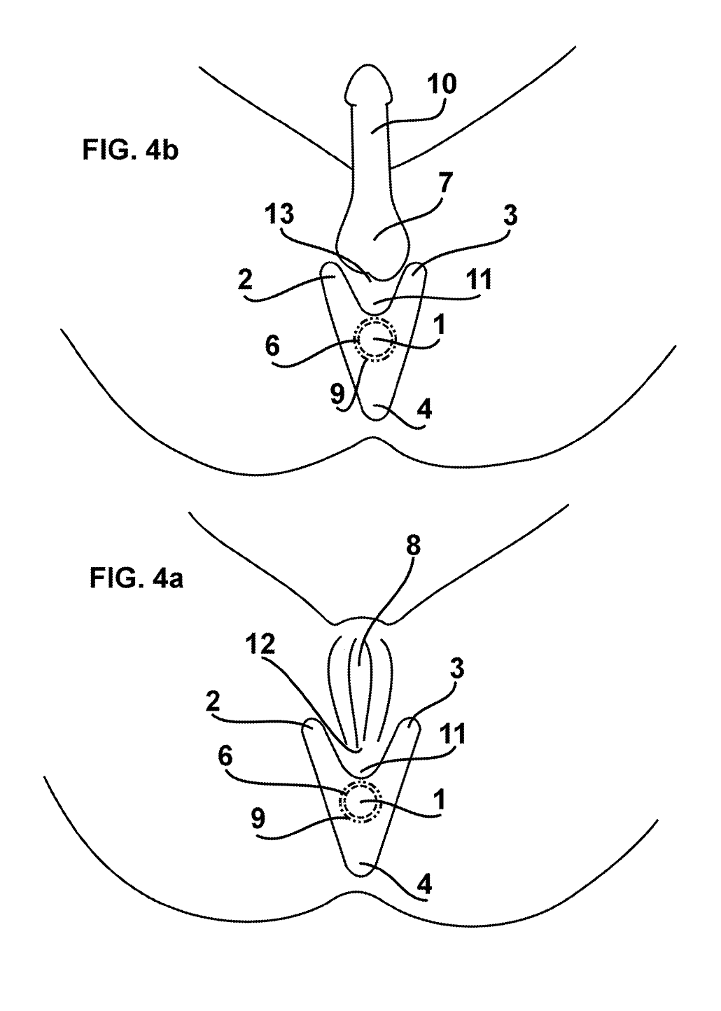

FIG. 4A to 4B are illustrations depicting anal insertion and positioning of the present invention in relationship to the vagina in a female and scrotum in a male with the two split legs straddling the user's perineum from the posterior position.

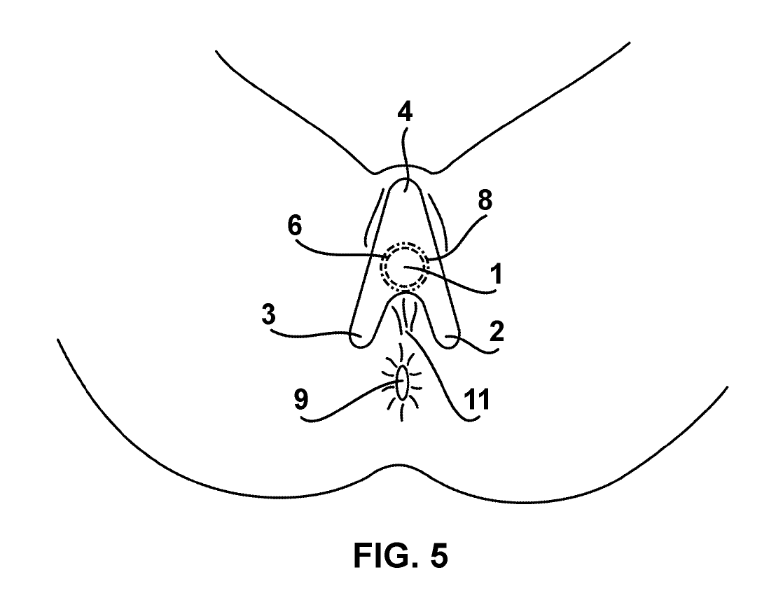

FIG. 5 shows an illustration depicting the invention inserted in a vagina, with the two split legs straddling the user's perineum from the anterior position.

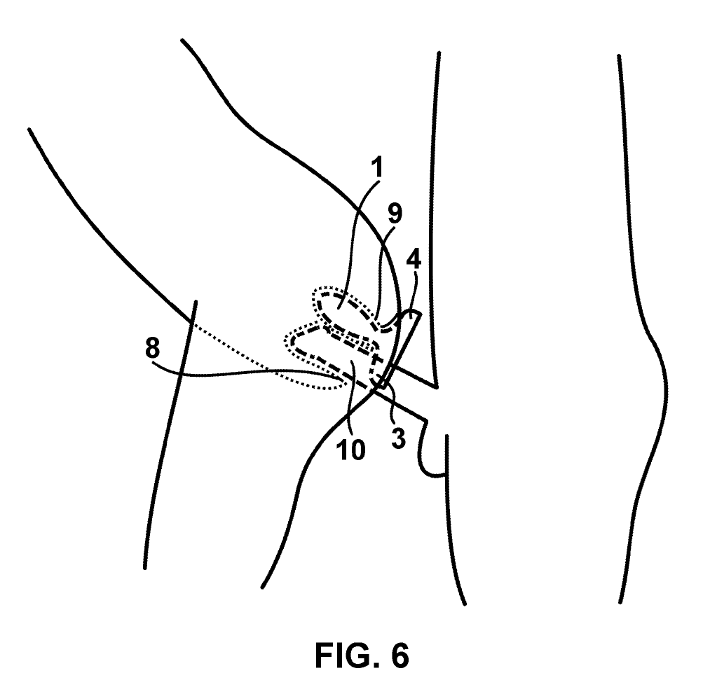

FIG. 6 shows an illustration depicting male-female coitus with the female using the present invention in its preferred embodiment anally inserted, with two legs of the base positioned facing the user's vagina.

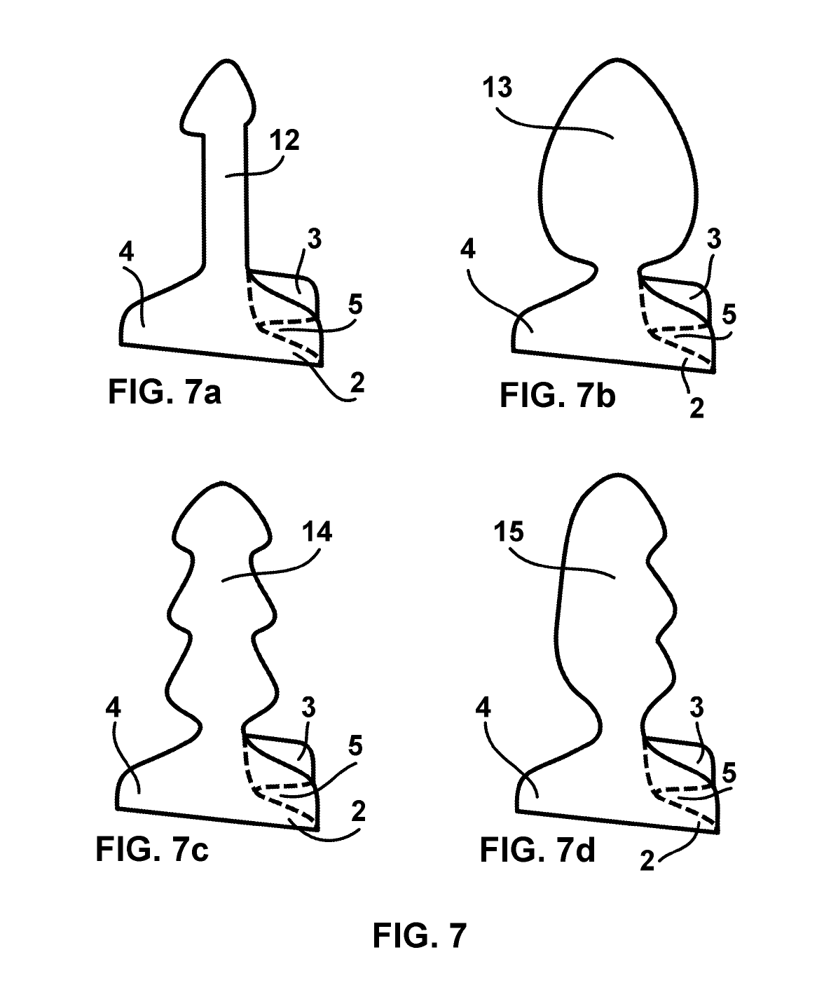

FIG. 7 shows a side view of the present invention and several embodiments.

Drawings - Reference Numerals

| | |
|---|---|
| 1 | Phallus or Anal Plug |
| 2 | Right Leg of Base |
| 3 | Left Leg of Base |
| 4 | Aft Leg of Base |
| 5 | Void in Base |
| 6 | Neck of Phallus or Anal Plug |
| 7 | Scrotum |
| 8 | Vagina |
| 9 | Rectum |
| 10 | Penis |
| 11 | Perineum |
| 12 | Female Anterior Fourchette |
| 13 | Base of the Scrotum |
| 14 | Phallus |
| 15 | Anal Plug |
| 16 | Anal Plug with Enhancements |

### DETAILED DESCRIPTION OF THE INVENTION

While dildos, vibrators, anal plugs, strap-ons and other sex devices can be and are frequently used for sexual stimulation when a suitable sexual partner is not available, as in solo play or masturbation, it is also common for such devises to be incorporated into sexual play between partners. The present invention is susceptible to embodiment taking many different forms as shown in detailed specific drawings and contained herein, with the understanding that the present invention disclosure of said embodiments is intended as an example of the principles and applications and is not intended to limit the present invention to the specific embodiments illustrated.

Typical use and insertion of prior art into a body cavity may result in the base or un-inserted end of the phallus, anal plug or strap-on fully or partially overlapping and or covering the entrance to the user's anus and or vagina, such that inserting the prior art into the user's anus or vagina effectively covers or overlaps the user's adjacent vaginal or anal opening with the flared and or un-inserted base, in the case of a female user, and the perineum and or scrotum of the male user. Sexual stimulation of or penetration of the user's unoccupied vaginal or anal cavity not occupied by the prior art becomes difficult if not impossible due to the base fully or partially blocking the free and unimpeded completion of vaginal intercourse, anal intercourse or the insertion of a second phallus, anal plug or strap-on as the base of the prior art protrudes partially over and or completely covers the user's anal or vaginal opening.

The Anogenital Distance (AGD) is the distance from the anus to the genitalia, the base of the penis or the vagina, and is commonly referred to as the perineum. In adult men, the mean AGD has been determined to be normally approximately 1.5″ plus or minus 0.5″, as measured from the center of the anus to the first fold of the scrotum, but can vary considerably due to congenital effects during gestation. In adult women, the median AGD has been determined to be 1.4″ plus or minus 0.3″, as measured from the center of the anus to the posterior fourchette.

The present invention relates to the discovery that the round, oval, square, rectangular or other anatomically modified bases of prior art either partially or fully interfere with and or impede the sexual stimulation of the user's perineum whether male or female, when the prior art is inserted rectally and effectively prevents the user from unimpeded vaginal penetration either by vaginal intercourse or by use of another phallus, anal plug or strap-on when the user is female. Conversely, when the female user inserts the prior art vaginally, the round, oval, square, rectangular or other anatomically modified base either partially or fully interferes with and or impedes the sexual stimulation of the user's perineum and prevents the user from unimpeded anal penetration either by anal intercourse or by use of another phallus, anal plug or strap-on.

For female AGD reference cited See Mendiola et al.: Anogenital distance is related to ovarian follicular number in young Spanish women: a cross-sectional study. Environmental Health 2012 11:90. http://www.ehjournal.net/content/pdf/1476-069X-11-90.pdf

For male AGD reference cited See M. L. Eisenberg et al.: The relationship between anogenital distance and age. American Society of Andrology and European Academy of Andrology 2012 http://onlinelibrary.wiley.com/enhanced/doi/10.1111/j.2047-2927.2012.00019.x/

The present invention and its embodiments allow for heightened sexual satisfaction of the female user and if used with a partner, their partner, by allowing for the exposure of the user's perineum, and by accommodating unimpeded vaginal intercourse or vaginal stimulation and penetration with a phallus, anal plug or strap-on when the present invention and/or its embodiments is inserted into the female user's anus. The present invention and its embodiments allow for heightened sexual satisfaction of the female user and if used with a partner, her partner, by allowing for exposure of the user's perineum, and by accommodating unimpeded anal intercourse or anal stimulation when the invention and/or its embodiments is inserted into the female's vagina.

The present invention and its embodiments allow for the heightened sexual satisfaction of the male user by allowing for the unimpeded exposure of the user's perineum and scrotum when the present invention or its embodiments is inserted into the user's anus.

The present invention and its embodiments feature a base that is split or slotted along one radial portion such that a portion of the flared base is effectively removed, creating a void sufficient for the user's perineum to be exposed as well as the anus and/or vagina to be free and clear of the obstruction or impedance of the prior art's flared base, such that a penis, phallus or anal plug may then be inserted into the user's body cavities not occupied by the present invention or its embodiments.

The present invention and its preferred embodiments comprise a split base, utilizing three distinct legs aligned with one leg perpendicular to the longitudinal axis of the insertable portion of the device or toy, and extending along the axis parallel to the user's posterior anal cleft, inserted anally by any user. This same leg aligns with and orientates to the female user's mons venus when inserted vaginally.

The present invention and its preferred embodiments incorporate two additional opposing legs perpendicular to the longitudinal axis of the insertable portion of the phallus or anal plug and extend at such equal and opposing angles as to straddle and expose the perineum of the user, creating a void in the base of the phallus or anal plug from the anterior edge of the anus where the user inserts the phallus or anal plug into his or her rectal cavity. The female user's vagina is unobstructed by these two legs. The size and shape, whether circular, oval or triangular, of the gap between these two legs is such that an average size and shaped penis, phallus or anal plug would not be partially or fully impeded or blocked from penetrating and thus providing enhanced sexual stimulation to the user's vagina when used by a female. When used by a male with a phallus or anal plug inserted into the rectal cavity, these two legs create a void between them in the base that allows for complete exposure of the perineum from the anterior edge of the anus to the base of the scrotum, enhancing the user's sexual stimulation.

The present invention and/or its embodiments is designed to support or stand upright the phallus or anal plug on its own, and is of sufficient size, design and structure to prevent the device or toy from being accidentally fully inserted and thus not easily retrievable from a body cavity.

As illustrated in FIG. 1 the present invention is shown in its preferred embodiment as an anal plug generally referred to by reference numeral 1. Different embodiments and iterations of the phallus or anal plug 1 base will be described below.

Every embodiment of the present invention consists of three legs 2, 3, 4 comprising the base radiating horizontal to the vertical insertable portion of the phallus 1 or anal plug 1. The present invention and its embodiments are made from a flexible material such as silicone, PVC, rubber, latex, an elastomeric compound, or some other flexible material, or a more rigid material such as plastic, metal or other compound. The two opposing legs 2, 3 create a void 5 in the base sufficient to expose the user's perineum, vagina and anus, depending upon where the user inserts the phallus 1 or anal plug 1.

The present invention and its embodiments have three legs 2, 3, 4 which when the insertable portion of the phallus 1 or anal plug 1 is inserted into the user's rectum, allows for aft leg 4 portion of the base to rest against the posterior portion of the gluteus cleft just aft of the anus. The other two opposing legs 2, 3 of the present invention are angled to radiate out from the centerline of the longitudinal axis of the phallus 1 or anal plug 1 equidistant from each other so that one leg 3 rests to the left side of the user's perineum, and one leg 2 rests to the right side of the user's perineum. Each of these two opposing legs 2, 3 of the present invention and its embodiments create a void in the base 5 and are designed to allow for unimpeded access to the user's perineum. When the user is female and inserts the phallus 1 or anal plug 1 into the rectum, the base legs 2, 3 allow for complete and unimpeded access to the vagina for coitus or insertion of another phallus, anal plug or strap-on. Male users of the present invention and its embodiments are afforded an unimpeded access to the user's perineum, external prostate spot and/or scrotum.

FIGS. 2a, 2b and 2c illustrates the plan view of the base of the invention in its preferred embodiments. FIG. 2a and variations including but not limited to the approximate 45 degree to 75 degree angular separation in creating the void 5 of the opposing legs 2, 3. In another embodiment FIG. 2b these two legs 2, 3, are separated by a semi-circular void 5 yet have an angular straight line on the outside edge tapering back to the remaining leg 4. In yet another embodiment of the present invention FIG. 2c, these legs 2, 3 can be formed to create a semi-circular void 5 in the separation of the legs and feature a curved tapered edge along both sides running back to the remaining third leg 4. These, and other embodiments, would allow design enhanced modifications to the present invention and its embodiments so as to accommodate the full and complete support of the phallus or anal plug, as well as the variations in the circumference size of the penis, phallus, anal plug or strap-on which the female user would insert into her vagina.

The present invention and its embodiments allow for the stem 6 of the phallus 1 or anal plug 1 to be clear of the base within the voided area 5 created by the two opposing legs 2, 3 when inserted into the anus or vagina, for complete access to the user's perineum.

FIGS. 3a and 3b illustrates the orthogonal view of the present invention in its preferred embodiment, from the posterior view 3a, and from the anterior view 3b, wherein the opposing legs 2, 3, are separated 5 from the medial centerline of the base along the perpendicular axis of the inserted portion of the phallus 1 or anal plug 1. The two opposing legs 2, 3 are separated by a distance sufficient to allow for the support of the insertable portion of the phallus 1 or anal plug 1 and along with the third leg 4 are of sufficient length and width to prevent accidental and possible irretrievable full insertion into the rectum or vagina of the user. The shape of the space separating these two legs 2, 3 is of a shape sufficient in keeping their separation with both legs 2, 3 merging together just outside the circumference of the neck 6 of the phallus 1 or anal plug 1 while the void 5 forms the approximate shape of a triangle, oval and or semi-circle so as to allow the user to expose his or her perineum and/or vagina and/or anus.

FIGS. 4a and 4b illustrates the present invention related to the positioning of the three legs 2, 3, 4 when the phallus 1 or anal plug 1 is inserted into the rectum 9 of a female 4a or the rectum 9 of the male 4b. The neck 6 of the phallus 1 or anal plug 1 rests in the user's anal opening of the rectum 9. In each case, the invention and its embodiments allow for the insertion of the shaft of the phallus 1 or anal plug 1 into the user's rectum 9, while simultaneously allowing for a sufficient base to support the phallus 1 or anal plug 1 when standing upright on the base, and to prevent its accidental and possible irretrievable full insertion into the rectum 9, or vagina 8, of the user as well as the full and complete access to the user's vagina 8, scrotum 7 or perineum 11. When the phallus 1, anal plug 1 is inserted into the user's rectum 9, the present inventions legs 2, 3, are thus facing the user's anterior fourchette 12 for a female 4a or the base 13 of the scrotum 7, for the male 4b. The two opposing legs 2, 3 thus straddle equidistant from the edge of the anal opening of the rectum 9, at the stem 6 of the phallus 1 or anal plug 1, leaving the user's perineum 11, vagina 8 or scrotum 7 exposed for heightened sexual stimulation by other means. In the case of the female 4a user, unimpeded insertion of a penis 10, phallus 1 or anal plug 1 into the female's vagina 8 allows for heightened sexual stimulation.

FIG. 5 illustrates the present invention relating to the positioning of the legs 2, 3, 4 when the phallus 1 or anal plug 1 is inserted into the vagina 8 of a female user. The present invention and its embodiments allow for the insertion of the shaft of the phallus 1 or anal plug 1 into the user's vagina 8 while simultaneously allowing for a sufficient base to support the phallus 1 or anal plug 1 when standing upright on the base, and to prevent is accidental and possible irretrievable full insertion into the vagina 8. When inserted into the user's vagina 8, two of the present inventions base legs 2, 3 are thus facing the user's perineum 11 and anal opening of the rectum 10. The two opposing legs 2, 3 thus straddle equidistant from the posterior edge of the vagina 8 at the stem 6 of the phallus 1 or anal plug 1, leaving the user's perineum 11 and anal opening of the rectum 9 for heightened sexual stimulation by other means and unimpeded insertion of a penis 10, phallus 1, anal plug 1 or strap-on into the females rectum 9 for heightened sexual stimulation.

FIG. 6 Is a cross sectional of the present invention fully inserted into a female user's rectum 9. The present invention's two opposing legs 2, 3 are facing the anterior fourchette of the female, allowing for the male to penetrate her vaginally with his penis 10 without interference or encumbrance from the base legs 2, 3, to the mutually enhanced sexual gratification of both the male and female. The present invention and its embodiments provide a complete and unencumbered access to the female user's vagina 8 when the phallus 1 or anal plug 1 is inserted into her rectum 9 in any sexual position, be it standing, on her back, side, knees or other variances of coitus.

### FIG. 7

### Alternative Embodiments

These figures represent the present invention and its embodiments in variations of application including a phallic shaped 7a phallus 1. The two separated legs 2, 3 can be aligned in any orientation to the longitudinal axis of the shaft of the phallus 1, but the preferred embodiment would align the base such that one leg 4 would align to the top of the phallus 1 shaft, and the remaining legs 2, 3 would align with the bottom of the phallus 1 shaft. The invention and its embodiments need no specific orientation of the base as it relates to egg-shaped 7b, round or symmetrical 7c shapes of the insertable portion of the phallus 1 or anal plug 1. The preferred embodiment for an 7d anal plug 1 which features protrusions or indentations designed for prostate stimulation, g-spot stimulation or other internal stimulation enhancement would see the alignment of the two opposing base legs 2, 3 in such a configuration that the portion of the anal plug 1 inserted into the user's rectum or vagina would allow for the correct placement of said enhancements facing in the correct alignment to the internal structures to be stimulated, while leaving the user's perineum and unoccupied rectum or vagina exposed and unimpeded thus enhancing sexual stimulation by a penis, phallus, anal plug or strap-on.

The examples and illustrations above are not intended to represent the entirety of the variations of the present invention and are not intended to be limiting variations. Variations in materials used, designs, shapes and sizes are within the application of the present invention and as such the claims below should not otherwise be limited.

### Advantages

From the description and illustrations above, several advantages and enhancements of my phallic base become evident:
(a) As with prior art, the ability to hold upright any iteration of a phallus or anal plug is accomplished with the distinct three legs of the present invention.
(b) As with prior art, the present invention also prevents the accidental and possible irretrievable full insertion of the phallus or anal plug into the vagina or rectum.
(c) Unlike prior art, the present invention provides the user with clear and unimpeded access to the users perineum from the edge of the anus to the vagina or scrotum when the phallus or anal plug is inserted in the rectum. The present invention provides the user with clear and unimpeded access to the user's perineum from the edge of the vagina to the anus when the phallus or anal plug is inserted into the vagina. The present invention and it's various listed and unlisted iterations and embodiments provide enhanced sexual satisfaction to the user in solo play as well as when used with a partner, due to the arrangement of the three legs and the resulting exposure of the user's perineum and surrounding tissue.

### CONCLUSION, RAMIFICATIONS AND SCOPE

Accordingly, the reader will see that the base of the various embodiments can be easily implemented in a variety of sex toys as highlighted, providing for the same level of support of the devices in their upright, self-standing potions, as well as those from other means of support and use. In addition, the base of the various embodiments provides sufficient protection from accidental over insertion and/or possible irretrievable full insertion of the sex toy.

Further, this base and its various embodiments provides a novel improvement and enhancement of the sex toy by allowing for the complete exposure and comfortable access to the users perineum and related erogenous zones of the anal genital regions of both female and male users. The sex toy industry is heavily influenced by the desires of the consumer for enhanced sexual gratification and the base of the present invention and its embodiments provides just such an enhancement, by allowing for more heightened tactile stimulation through increased skin exposure and the nerve endings of the associated erogenous zones. The exposure of this area afforded by the base and its various embodiments has the additional advantages as follows:
it increases the likelihood of enhanced sexual satisfaction to the user by allowing for the highly sensitive erogenous zones of the anal genital regions to be exposed to stimulation;
it is gender neutral, in that both female and male users will benefit from the enhanced stimulation equally;
it does not interfere with or negatively modify the typical methods of use of the sex toy,
it continues to provide the upright support of the sex toy as a base is designed to do;
it provides equal or superior prevention from accidental over insertion;
it is easily scalable in size to accommodate various embodiments without the loss of intended functions.

Although the description above contains many specificities, these should not be construed as limiting the scope of the embodiments but as merely providing illustrations of some of several embodiments. For example, the angles, size and general shape of the three legs may vary, according to their application of the embodiment, while the three legs retain their general functions as set forth above. Thus the scope of the embodiments should be determined by the appended claims and their legal equivalents, rather than by the examples given.

What is claimed:

1. A sexual stimulation device base comprising:
a. a phallus, anal plug or strap-on of any insertable configuration which includes a base for the purpose of holding the phallus or anal plug upright or for the prevention of accidental and possibly irretrievable over insertion, and
b. said base is comprised of three legs such that a space or void in said base is created in the base between the legs, to the neck of the phallus, anal plug or strap-on, that allows for the proper alignment of the phallus, anal plug or strap-on, and
c. said space or void provides a means by which there is enhanced exposure and sexual stimulation to the users perineal area once the phallus, anal plug or strap-on is inserted into the user's vagina or anus, thus allowing for the complete and unimpeded access to the female or male user's perineum, unoccupied vagina or anus, and scrotum, enhancing the sexual satisfaction of the user and or there partner.
